(19) United States
(12) Patent Application Publication
(10) Pub. No.: US 2013/0023164 A1
(43) Pub. Date: Jan. 24, 2013

(54) CASE STRUCTURE OF A GROUND ROD

(71) Applicant: Ping-Yi HUANG, Kaohsiung City (TW)

(72) Inventor: Ping-Yi HUANG, Kaohsiung City (TW)

(21) Appl. No.: 13/185,521

(22) Filed: Jul. 19, 2011

(51) Int. Cl. H01R 11/09

(52) U.S. Cl. 439/794

(57) ABSTRACT

A case structure of a ground rod includes a first block having a positioning hole, a second block having a positioning hole, a through-hole and a gap communicating with the through-hole. The positioning holes of the first and second blocks are capable of being extended through by a fixing member to adjust a width of the gap.

### BACKGROUND OF THE INVENTION

1. Field of the Invention

The present invention generally relates to a case structure of a ground rod and, more particularly, to a case structure of a ground rod that can securely fix the ground rod with a ground wire together.

2. Description of the Related Art

Buildings often have an electrical circuit for connecting to appliances. However, electric leakage can occur on the electrical circuitry or the buildings can be struck by lightening. To prevent such dangers, a ground system must be constructed in the building. Usually, the ground system has a ground wire connected to ground. The ground wire is usually buried into the ground together with a ground rod. To couple the ground wire with the ground rod, a case structure should be provided for the ground rod. When the ground rod is inserted into the ground, one should extend the ground wire through the case structure and then fix the case structure to the ground rod via a plurality of screws. In generally, the ground rod is driven into the ground by striking. However, the striking force tends to knock the ground wire off the ground rod, leading to a poor coupling between the ground wire and the ground rod.

In light of this problem, a Taiwanese Patent No. 423744 directed to a ground rod with improved electricity conductivity was proposed. The ground rod has an outer face, and decorative patterns are arranged on the outer face at one end of the ground rod. A case structure having two sleeve portions (large and small sleeve portions) is provided to bind a ground wire to the ground rod. The ground wire has a metal portion and an insulated wrapping portion. The metal portion is received in the small sleeve portion and the insulated wrapping portion is received in the large sleeve portion. Then, a punching process is applied to the ground rod and the ground wire using a hydraulic press. In this way, the small sleeve portion of the case structure will tightly fix the metal portion of the ground wire to the ground rod, and the large sleeve portion of the case structure will tightly fix the insulated wrapping portion of the ground wire to the ground rod. Thus, the case structure can be tightly coupled with the ground rod by way of punching. However, the punching process will make the ground wire become fragile. As a result, the ground wire will easily break or come off the ground rod when burying the ground rod and the ground wire into the ground. Thus, the ground wire cannot be inserted very deep into the ground, leading to a poor grounding effect of the ground wire. Furthermore, the punching process can only be applied to a thin ground wire (with small diameter). In other words, a thick ground wire (with large diameter) cannot be extended through the case structure and be fixed to the ground rod by punching process.

### SUMMARY OF THE INVENTION

It is therefore the primary objective of this invention to provide a case structure of a ground rod which allows a ground wire to be tightly fixed to the case structure.

It is another objective of this invention to provide a case structure of a ground rod which can be applied to various ground wires with different size.

It is yet another objective of this invention to provide a case structure of a ground rod which allows the case structure and a ground wire to be tightly fixed to the ground rod when being buried into the ground.

The invention discloses a case structure of a ground rod, which includes a first block having a positioning hole, a second block having a positioning hole, a through-hole and a gap communicating with the through-hole. The positioning holes of the first and second blocks are capable of being extended through by a fixing member to adjust a width of the gap.

### BRIEF DESCRIPTION OF THE DRAWINGS

The present invention will become more fully understood from the detailed description given hereinafter and the accompanying drawings which are given by way of illustration only, and thus are not !imitative of the present invention, and wherein:

FIG. 1 is an exploded view of a first embodiment of the invention.

FIG. 2 is a top view of the first embodiment according to a first exemplary use of the invention.

FIG. 3 is a cross-sectional view observed at line 3-3 in FIG. 2.

FIG. 4 is a cross-sectional view of the first embodiment according to a second exemplary use of the invention.

FIG. 5 shows an installation of the first embodiment according to the first exemplary use of the invention.

FIG. 6 shows an installation of the first embodiment according to the second exemplary use of the invention.

FIG. 7 is an exploded view of a second embodiment of the invention.

FIG. 8 is a top view of the second embodiment of the invention.

FIG. 9 is a cross-sectional view of the second embodiment of the invention observed at line 9-9 in FIG. 8.

FIG. 10 is a top view of a modified second embodiment of the invention.

FIG. 11 is an exploded view of a third embodiment of the invention.

FIG. 12 is a cross-sectional view of the third embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

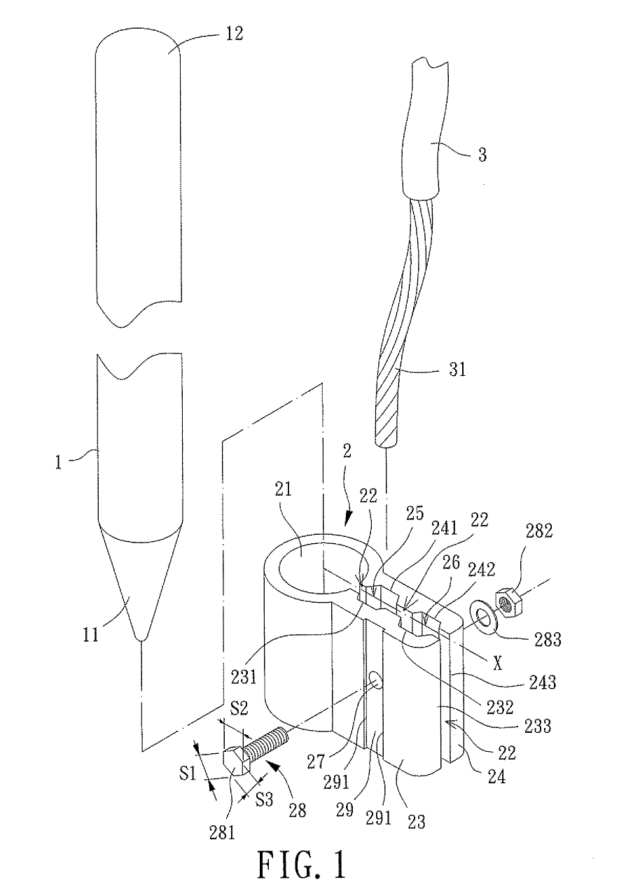

Referring to FIG. 1, a first embodiment of the invention comprises a ground rod 1, a case structure 2 and a ground wire 3. The ground wire 3 can be securely coupled with the case structure 2. The case structure 2 and the ground wire 3 can be securely fixed to the ground rod 1.

The ground rod 1 can be made of various known materials with electricity conductivity. The ground rod 1 has a first end 11 in a tapered form, allowing the ground rod 1 to be inserted deep into the ground. The ground rod 1 also has a second end 12 that can extend through the case structure 2.

The case structure 2 can be made of various known materials with electricity conductivity. The case structure 2 has a through-hole 21 and a gap 22 communicating with the through-hole 21, and can be separated into a first block 23 and a second block 24 by a central line X. The through-hole 21 may correspond to a rough outer circumferential face of the ground rod 1. The gap 22 may clip the ground wire 3. Both the first block 23 and the second block 24 may have a positioning hole 27 corresponding to each other. The positioning holes 27 of the first block 23 and the second block 24 may be extended through by a fixing member 28 to adjust the width of the gap 22. In this embodiment, the fixing member 28 can be a screw bolt threadedly engaged with a screw nut 282. When necessary, the screw bolt may be provided with a washer 283. By screwing the fixing member 28, the gap 22 can be formed between the first block 23 and the second block 24. To facilitate screwing the screw bolt and the screw nut 282 together, the first block 23 or the second block 24 may include a concave hole or a furrow 29 on a surface thereof In this embodiment, the furrow 29 is arranged on the surface of the first block 23, and the furrow 29 has two inner lateral walls 291. In addition, the fixing member 28 includes a head portion 281 having a plurality of pairs of parallel sides S1, S2 and S3. In such an arrangement, the fixing member 28 may extend through the positioning holes 27 of the first block 23 and the second block 24 until the head portion 281 is engaged in the furrow 29. Note when the head portion 281 is engaged in the furrow 29, one of the plurality of pairs of parallel sides S1, S2 and S3 will firmly abut against the two inner lateral walls 291 of the furrow 29.

The first block 23 may form a limiting portion 233 on a free end thereof, with the limiting portion 233 extending towards the second block 24. Similarly, the second block 24 may form a limiting portion 243 on a free end thereof, with the limiting portion 243 extending towards the first block 23. To prevent the ground wire 3 from escaping from the gap 22, at least one of the limiting portions 233 and 243 should be arranged. A distance between the limiting portions 233 and 243 is smaller than the gap 22 between the first block 23 and the second block 24.

To securely clip the ground wire 3 between the first block 23 and the second block 24, the first block 23 may include a plurality of concave portions 231 and 232 on a face facing the second block 24, and the second block 24 may include a plurality of concave portions 241 and 242 on a face facing the first block 23. The concave portion 231 of the first block 23 and the concave portion 241 of the second block 24 can jointly define a first hole 25. Similarly, the concave portion 232 of the first block 23 and the concave portion 242 of the second block 24 can jointly define a second hole 26. This allows the case structure 2 to have at least two holes 25 and 26. The cross section of the first hole 25 and the second hole 26 may be in various shapes, such as a rectangular shape, a trapezoid shape, a trapezoid shape, a round shape etc. The first hole 25 and the second hole 26 can be extended through by a metal wire 31 of the ground wire 3. Furthermore, a center of the first hole 25 is preferably not located on the central line X. Similarly, a center of the second hole 26 is preferably not located on the central line X. In other words, the center of the first hole 25 is preferably located on one side of the central line X, and the center of the second hole 26 is preferably located on the other side of the central line X. Thus, the centers of the first hole 25 and the second hole 26 are located on two sides of the central line X. In such an arrangement, the center of the first hole 25 is closer to the second block 24 than the center of the second hole 26 is, and the center of the second hole 26 is closer to the first block 23 than the center of the first hole 25 is. When the fixing member 28 is used to adjust the width of the gap 22, the portion of the metal wire 31 received in the first hole 25 and the portion of the metal wire 31 received in the second hole 26 will have a mutual shift in a direction perpendicular to the central line X. Thus, the metal wire 31 can be clipped between the first block 23 and the second block 24 in a secure manner.

The ground wire 3 may be an electric cord commonly known, with the metal wire 31 thereof coated with an insulation layer. The ground wire 3 is in the form of a plurality of strands twisted together, and has one end connected to the case structure 2 when the other end thereof is connected to a building or an electric appliance.

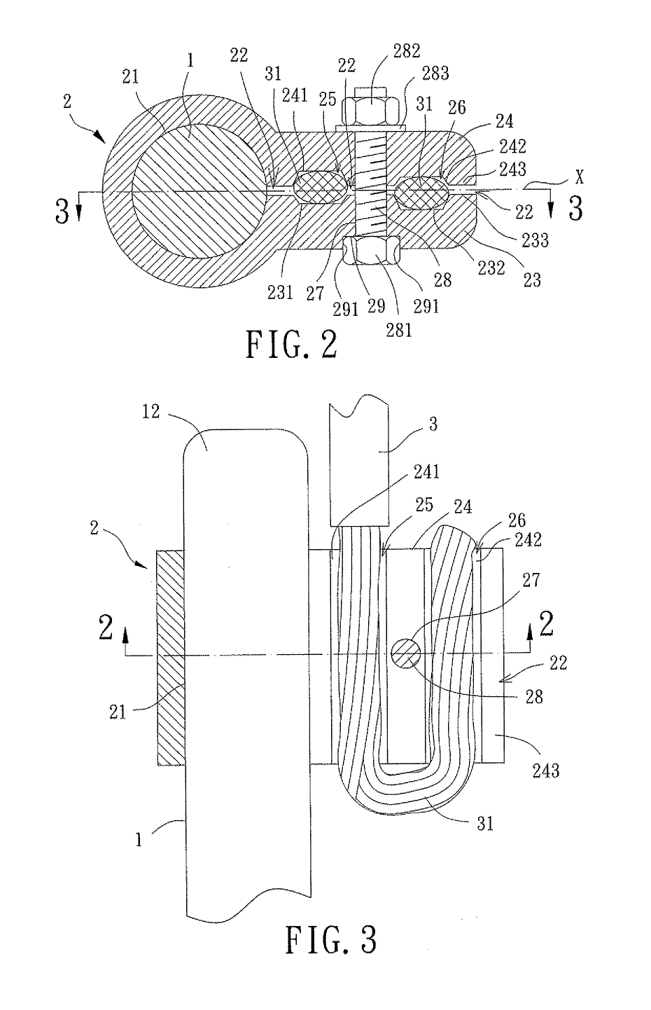

Referring to FIGS. 2 and 3, when in use, the ground rod 1 is extended through the through-hole 21 of the case structure 2. When the ground wire 3 has a small diameter (thin ground wire), the ground wire 3 can be extended through an area defined between the first block 23 and the second block 24, and is then bent backwards and extended back through the area. Specifically, the metal wire 31 of the ground wire 3 is extended through the first hole 25 from an upper side of the case structure 2. Then, the metal wire 31 is bent backwards by 180 degrees at a bottom side of the case structure 2 and is extended through the second hole 26. Finally, the fixing member 28 is driven to fix the first block 23 and the second block 24 together to securely clip the metal wire 31 between the first block 23 and the second block 24. In this manner, the ground wire 3 can be securely fixed to the case structure 2, and the case structure 2 and the ground rod 1 can be securely coupled with each other. Furthermore, due to the mutual shift between the two portions of the metal wire 31 respectively received in the first hole 25 and the second hole 26, the ground wire 3 can be fixed to the case structure 2 in a secure way when the fixing member 28 is driven in a full extent that best fixes the first block 23 and the second block 24 together. Further, one face of the first block 23 defining the gap 22 is in a stepped form, a waved form or an inclined form. Also, one face of the second block 24 defining the gap 22 is also in the stepped form, waved form or inclined form. Due to the stepped form, waved form or inclined form, the ground wire 3 can be better fixed to the case structure 2.

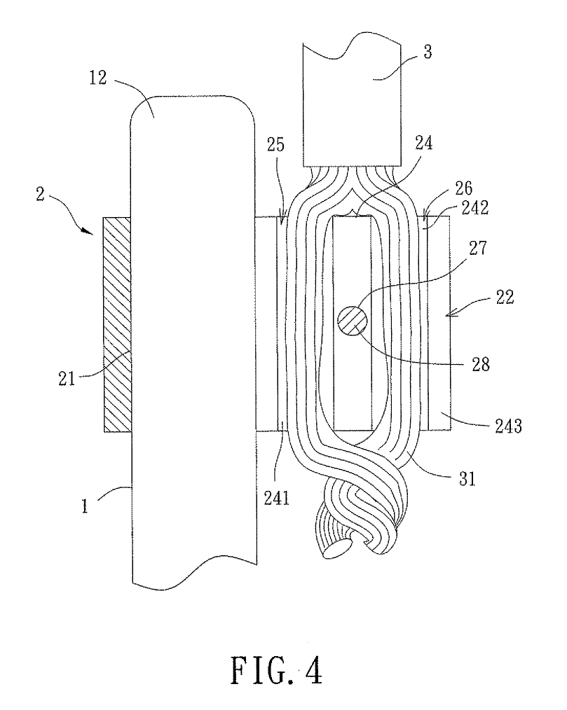

Referring to FIG. 4, a preferred usage of the invention is shown. The ground rod 1 is extended through the through-hole 21 of the case structure 2. When the ground wire 3 is thick (having a larger diameter), the metal wire 31 of the ground wire 3 can be divided into two or more strands. The two strands of the metal wire 31 can be kept away from each other and inserted into the gap 22 from an upper side of the fixing member 28. The two strands of the metal wire 31 then extend through the blocks 23 and 24 downwards on two sides of the fixing member 28, and can be twisted together at a lower side of the fixing member 28. Specifically, the two strands are respectively inserted into the first hole 25 and the second hole 26 from the upper side of the fixing member 28, and are twisted together at the lower side of the fixing member 28. In such a manner, the case structure 2 can be applied to any thick ground wire 3 with large diameter. In addition, the ground rod 1 can be tightly bound by a circumferential wall of the through-hole 21 when the fixing member 28 is driven to fix the first block 23 and the second block 24 together. In this way, the ground rod 1 can be tightly coupled with the case structure 2.

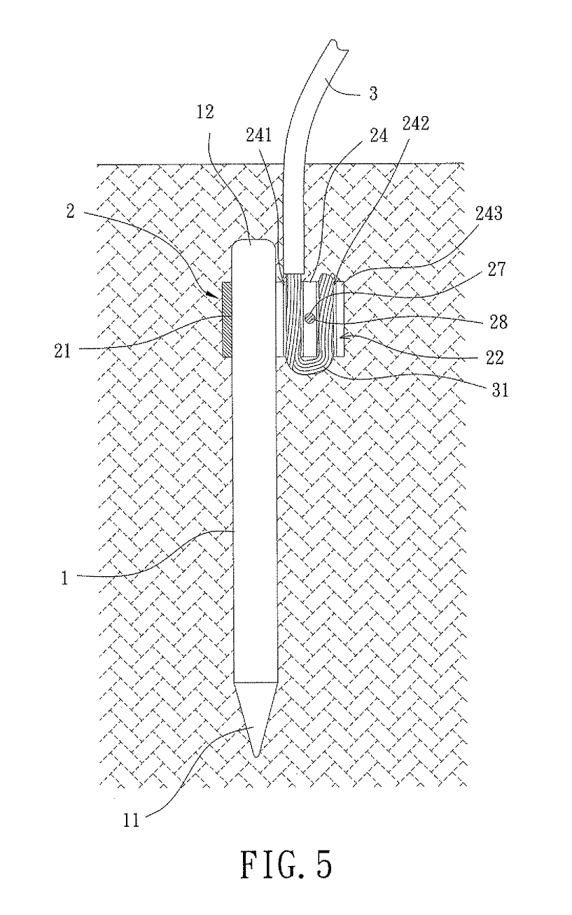

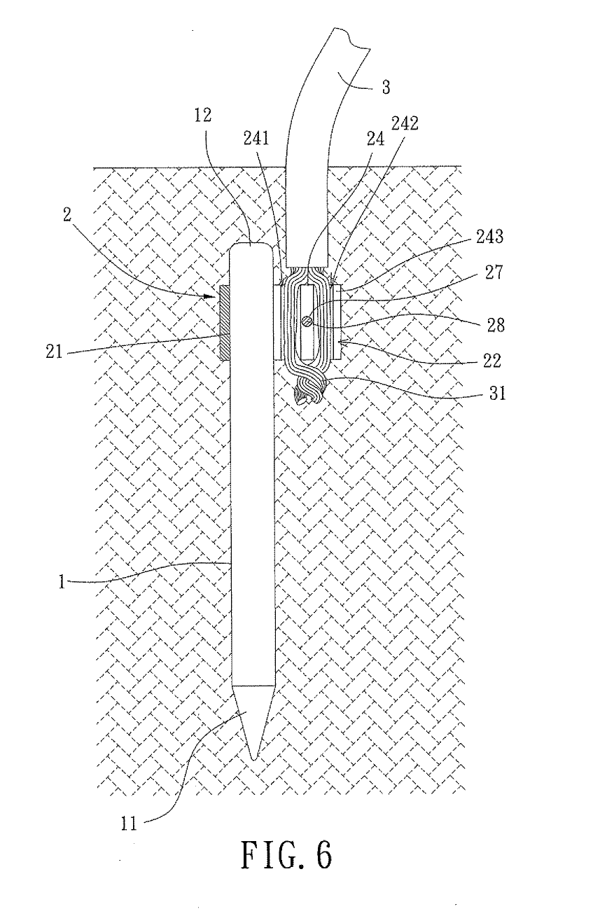

Referring to FIG. 5, when the ground wire 3 is coupled with the case structure 2, the metal wire 31 of the ground wire 3 is firstly inserted through the first hole 25. Then, the metal wire 31 is bent backwards and inserted into the second hole 26. Alternatively, referring to FIG. 6, the metal wire 31 is divided into two strands first. Then, the two strands are respectively inserted through the first hole 25 and the second hole 26 from the upper side of the fixing member 28, and are twisted together at the lower side of the fixing member 28. In such an arrangement, when the ground rod 1 is inserted into the ground by striking, the ground wire 3 won't come off the ground rod 1.

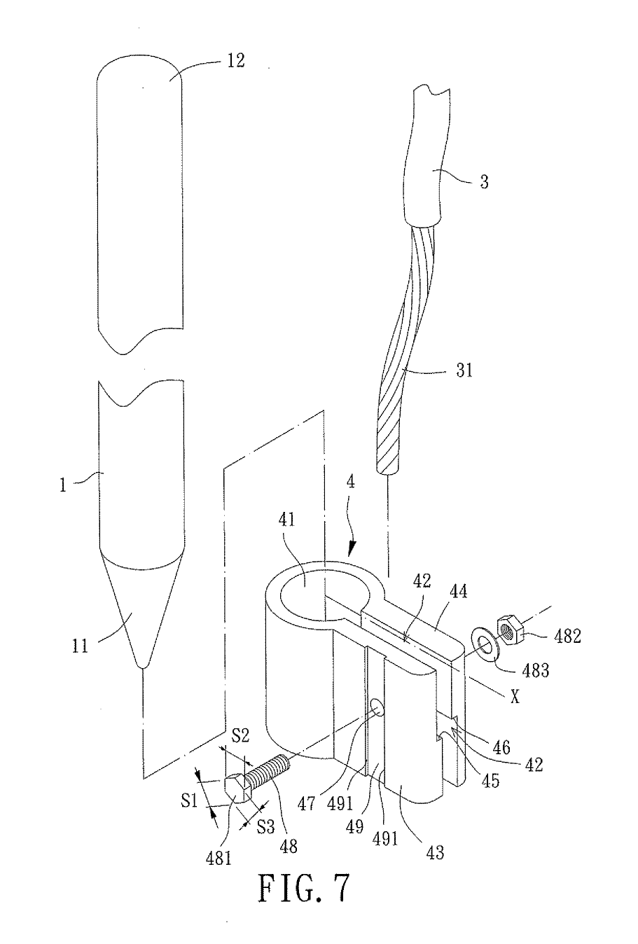

Referring to FIG. 7, a case structure 4 is shown according to a second embodiment of the invention. The case structure 4 can be made of various known materials with electricity conductivity. The case structure 4 has a through-hole 41 and a gap 42 communicating with the through-hole 41, and can be separated into a first block 43 and a second block 44 by a central line X. The first block 43 and the second block 44 are designed in a way that the gap 42 therebetween can change in an axial direction parallel to the ground rod 1. Specifically, the first block 43 is designed to have an unequal difference in the axial direction, so that a first shoulder portion 45 is formed on an inner face of the first block 43. Similarly, the second block 44 is designed to have an unequal difference in the axial direction, so that a second shoulder portion 46 is formed on an inner face of the second block 44. The first shoulder portion 45 and the second shoulder portion 46 are spaced from each other by a distance in the axial direction. Both the first shoulder portion 45 and the second shoulder portion 46 may be implemented in a stepped form, a waved form, a saw-toothed form or an inclined form. In this embodiment, the upper portion of the first block 43 has a smaller thickness than the lower portion thereof, thereby forming the first shoulder portion 45. Similarly, the upper portion of the second block 44 has a larger thickness than the lower portion thereof, thereby forming the second shoulder portion 46.

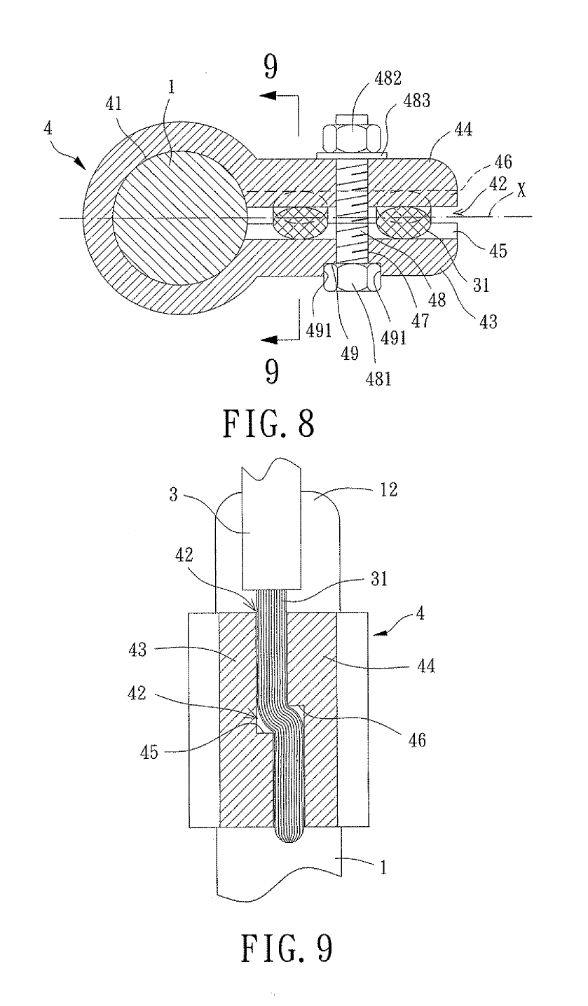

Referring to FIGS. 8 and 9, when it is desired to fix the ground wire 3 to the case structure 4, a fixing member 48 is extended through positioning holes 47 of the first block 43 and the second block 44. Then, the metal wire 31 of the ground wire 3 is inserted into an area between the first block 43 and the second block 44. The metal wire 31 is then drawn around the fixing member 48 and bent backwards to fix the metal wire 31 between the first block 43 and the second block 44. Alternatively, the metal wire 31 can also be separated into two strands as shown in FIG. 6. The two strands of the metal wire 31 can be kept away from each other and inserted into the area between the first block 43 and the second block 44 from an upper side of the fixing member 48. The two strands of the metal wire 31 then extend through the blocks 43 and 44 downwards on two sides of the fixing member 48, and are twisted together at a lower side of the fixing member 48. Finally, a screw nut 482 and a washer 483 can be provided and screwed together to clip the metal wire 31 between the first block 43 and the second block 44.

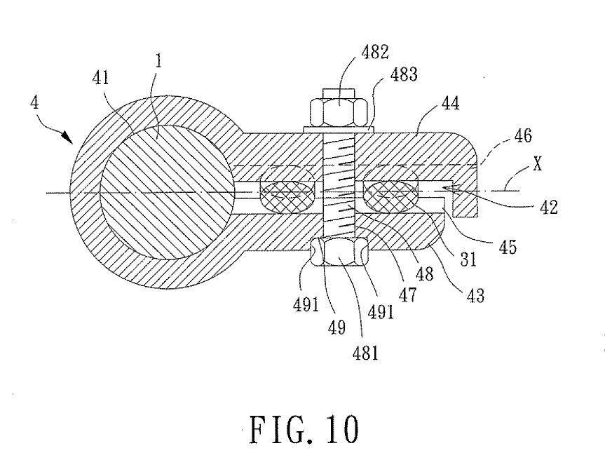

In another implementation, the case structure 4 of the second embodiment may be modified for further improvement. Referring to FIG. 10, a top view of a modified case structure 4 is shown. In this modification, one of the first block 43 and the second block 44 may further include a wire-retaining portion that extends from the free end thereof. In this embodiment shown in FIG. 10, the wire-retaining portion is formed on the free end of the second block 44 and extends over the first block 43 by a distance larger than the width of the gap 42. In such an arrangement, the metal wire 31 can be prevented from escaping from the area between the first block 43 and the second block 44 via the gap 42. This modified case structure 4 not only clips the metal wire 31 therein in a secure way but also efficiently prevents the disengagement of the metal wire 31. It is noted that the wire-retaining portion may also be formed on the free end of the first block 43 and extends over the second block 44 by the distance larger than the width of the gap 42 to keep the metal wire 31 between the first block 43 and the second block 44.

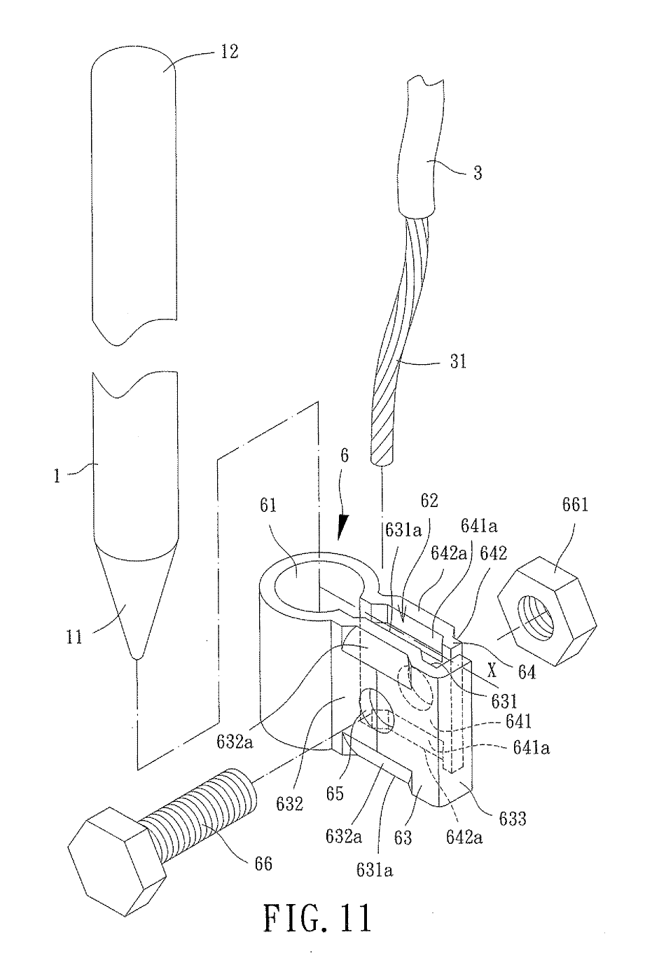

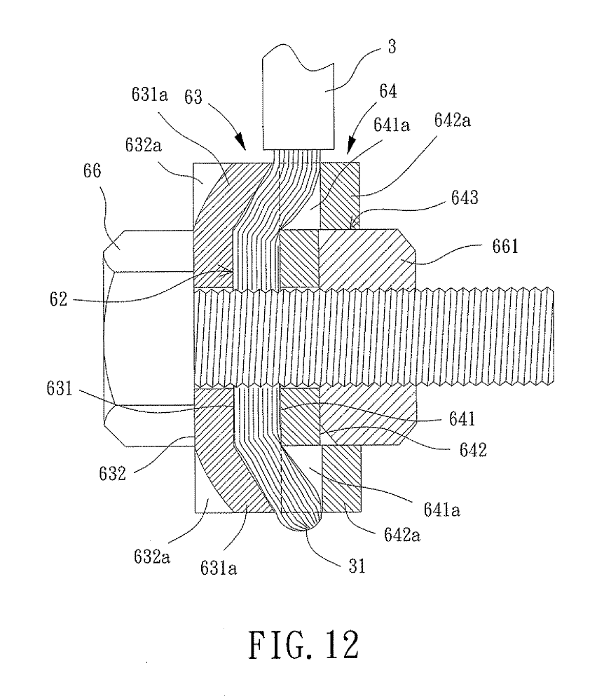

Referring to FIG. 11, a case structure 6 is shown according to a third embodiment of the invention. The case structure 6 can be made of various known materials with electricity conductivity. The case structure 6 has a through-hole 61 and a gap 62 communicating with the through-hole 61, and can be separated into a first block 63 and a second block 64 by a central line X. In this embodiment, both the first block 63 and the second block 64 have a positioning hole 65, and a fixing member 66 can be extended through the positioning holes 65 to fix the first block 63 and the second block 64 together. In addition, the first block 63 has an inner face 631 and an outer face 632, and the second block 64 has an inner face 641 and an outer face 642. The inner faces 631 and 641 jointly define the gap 62. The inner face 631 of the first block 63 has a pair of protruding portions 631a on upper and lower sides thereof, and the outer face 632 of the first block 63 has a pair of concave portions 632a on upper and lower sides thereof. Similarly, the inner face 641 of the second block 64 has a pair of concave portions 641a on upper and lower sides thereof, and the outer face 642 of the second block 64 has a pair of protruding portions 642a on upper and lower sides thereof. The protruding portions 631a of the first block 63 correspond to the concave portions 632a of the second block 64 in location and shape. The protruding portions 642a of the second block 64 can jointly define a furrow 643 on the outer face 642 thereof. In such an arrangement, the metal wire 31 can be inserted between the first block 63 and the second block 64, and the fixing member 66 can then be extended through the positioning holes 65 to fix the first block 63 and the second block 64 together. When the first block 63 and the second block 64 are fixed together in a full extend, the metal wire 31 will be securely clipped between the protruding portions 631a and the concave portions 641a. This prevents disengagement of the metal wire 31. In addition, a screw nut 661 can also be threadedly-engaged with the fixing member 66. The screw nut 661 is preferably engaged with the fixing member 66 in such a way that the screw nut 661 is fully received in the furrow 643 defined by the protruding portions 642a of the second block 64, as shown in FIG. 12. Similar to the case structure 4 of the second embodiment, a wire-retaining portion 633 can also be formed on the first block 63 (or the second block 64) to prevent disengagement of the metal wire 31. Note the protruding portions 631a and the concave portions 632a of the first block 63, as well as the concave portions 641a and the protruding portions 642a of the second block 64, can be formed by way of punching process. This provides a more convenient manufacturing than the case structure 4 shown in FIG. 7.

Also note that the inner face 631 of the first block 63 can also have only one protruding portion 631a, and the outer face 632 of the first block 63 can also have only one concave portion 632a. Similarly, the inner face 641 of the second block 64 can also have only one concave portion 641a, and the outer face 642 of the second block 64 can also have only one protruding portion 642a. In such as arrangement, the metal wire 31 can also be clipped between the protruding portion 631a and the concave portion 641a to prevent disengagement of the metal wire 31.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A case structure of a ground rod, comprising:
a first block having a positioning hole;
a second block having a positioning hole; and
a through-hole and a gap communicating with the through-hole;
wherein the positioning holes of the first and second blocks are capable of being extended through by a fixing member to adjust a width of the gap,

2. The case structure of the ground rod as claimed in claim 1, wherein one of the first and second blocks has a limiting portion on a free end thereof, and the limiting portion protrudes towards the other of the first and second blocks not having the limiting portion.

3. The case structure of the ground rod as claimed in claim 1, wherein each of the first and second blocks has a limiting portion on a free end thereof, the limiting portion of the first block protrudes towards the second block, and the limiting portion of the second block protrudes towards the first block.

4. The case structure of the ground rod as claimed in claim 1, wherein the first block has a plurality of concave portions on a face thereof facing the second block, the second block has a plurality of concave portions on a face thereof facing the first block, and the concave portions of the first and second faces jointly define at least two holes.

5. The case structure of the ground rod as claimed in claim 4, wherein the gap has a central line, one of the at least two holes has a center located at one side of the central line, and the other of the at least two holes has a center located at the other side of the central line.

6. The case structure of the ground rod as claimed in claim 1, wherein the first block has a first shoulder portion, the second block has a second shoulder portion, the first and second shoulder portions are spaced from each other by a distance in an axial direction, and both the first and second shoulder portions are implemented in a stepped form, a waved form, a saw-toothed form or an inclined form.

7. The case structure of the ground rod as claimed in claim 1, wherein the first or second block comprises a concave hole or a furrow on a surface thereof.

8. The case structure of the ground rod as claimed in claim 1, wherein the case structure is capable of being coupled with a metal wire of a ground wire, the metal wire is inserted into the gap from a side of the fixing member, and is then drawn around the fixing member and bent backwards at the other side of the fixing member.

9. The case structure of the ground rod as claimed in claim 1, wherein the case structure is capable of being coupled with a metal wire of a ground wire, the metal wire is separated into two strands, the two strands of the metal wire are inserted into the gap on two lateral sides of the fixing member, and are twisted together at a lower side of the fixing member.

10. The case structure of the ground rod as claimed in claim 5, wherein the first block further comprises a wire-retaining portion on a free end thereof, and the wire-retaining portion extends over the second block by a distance larger than the width of the gap.

11. The case structure of the ground rod as claimed in claim 1, wherein the first block further comprises inner and outer faces, the second block further comprises inner and outer faces, the inner face of the first block has two protruding portions, and the outer face of the first block has two concave portions, the inner face of the second block has two concave portions, and the outer face of the second block has two protruding portions, the two protruding portions of the inner face of the first block correspond to the two concave portions of the inner face of the second block in location and shape.

12. The case structure of the ground rod as claimed in claim 11, wherein the fixing member extends through the positioning holes of the first and second blocks, the two protruding portions of the second block jointly define a furrow on the outer face of the second block, and the case structure further comprises a screw nut threadedly-engaged with the fixing member and received in the furrow.

13. The case structure of the ground rod as claimed in claim 1, wherein the first block further comprises inner and outer faces, the second block further comprises inner and outer faces, the inner face of the first block has one protruding portion, and the outer face of the first block has one concave portion, the inner face of the second block has one concave portion, and the outer face of the second block has one protruding portion, the protruding portion of the inner face of the first block corresponds to the concave portion of the inner face of the second block in location and shape.
